(19) United States
(12) Patent Application Publication
(10) Pub. No.: US 2005/0281165 A1
(43) Pub. Date: Dec. 22, 2005

(54) Copy protection of optical discs

(75) Inventors: Philippe Marcel Henri Selve, Wokingham (GB); Victor Kovner, Maidenhead (GB)

Correspondence Address: PATENT DEPARTMENT;MACROVISION CORPORATION, 2830 DE LA CRUZ BLVD., SANTA CLARA, CA, 95050, US

(73) Assignee: Macrovision Corporation

(21) Appl. No.: 11/166,570

(22) Filed: Jun. 24, 2005

Related U.S. Application Data
(63) Continuation-in-part of application No. 10/981,890, filed on Nov. 5, 2004.

(30) Foreign Application Priority Data
Nov. 7, 2003 (GB) 0326132.8

(51) Int. Cl. G11B 15/04

(52) U.S. Cl. 369/53.21

(57) ABSTRACT

According to one standard, a multiple session audio disc has only two sessions, namely an audio session including successive audio tracks, and a following data session including just one data track. It has been determined that where copying of such a disc is to be undertaken using several common Microsoft Windows operating systems, the disc can be copy protected by breaching the rules of this standard. Specifically, if a two session audio disc is provided which has two tracks in the second data session, the Windows NT, Windows 2000 and Windows XP operating systems will fail to reconcile the data on the disc. As the operating systems are prevented from copying the audio information on the disc the use of the non-standard format acts to copy protect the optical disc.

### CROSS REFERENCE TO RELATED APPLICATIONS

This application is a continuation-in-part of U.S. pending application Ser. No. 10/981,890, which claims the priority data of 7th Nov. 2003, is entitled IMPROVEMENTS IN OR RELATING TO THE COPY PROTECTION OF OPTICAL DISCS and is incorporated herein by reference.

### BACKGROUND TO THE INVENTION

The present invention relates to a method of preventing copying of an optical disc.

Digital audio compact discs (CD-DA) which carry music or other audio can be played not only on CD players but can also be played on more sophisticated apparatus, such as CD-ROM drives which can also read the data on the disc. This means, for example, that the data on a CD-DA acquired by a user may be read into a PC by way of its ROM drive and thus copied onto another disc or other recording medium. The increasing availability of recorders able to write to CDs is therefore an enormous threat to the music industry.

WO 00/74053 proposes copy protecting audio data on a digital audio compact disc by rendering control data encoded onto the disc incorrect and/or inaccurate. The incorrect data encoded onto the CD is either inaccessible to, or not generally used by, a CD-DA player. Therefore, a legitimate audio CD bought by a user can be played normally on a compact disc music player. However, the incorrect data renders protected audio data on the CD unplayable by a CD-ROM drive.

However, as the protected audio data is rendered unplayable on a CD-ROM drive, the user is also prevented from using the CD-ROM drive legitimately simply to play the music or other audio on the disc.

It clearly would be advantageous to provide a method of copy protection for optical discs which, whilst preventing the production of usable copy discs, would not prevent or degrade, for example, the playing of legitimate audio discs on all players having the functionality to play audio discs. Examples of such copy protection methods are described in WO 01/61695 and in WO 01/61696.

### SUMMARY OF THE INVENTION

The present invention seeks to provide alternative copy protection methods.

According to the present invention there is provided a method of preventing copying of an optical disc, where the optical disc carries information and control data for enabling access to the information, the method comprising providing an optical disc having the information thereon arranged in a first session and in at least one consecutively arranged further session, each of said first and further sessions having a Lead-In, a program area, and a Lead-Out, and the first session being an audio session having audio data in its program area, wherein to prevent copying of the information on the optical disc when utilising a Microsoft operating system in the group: Windows NT, Windows 2000 and Windows XP, the Lead-In of said at least one further session specifies that there are at least two tracks on the optical disc arranged in one or more further sessions.

An optical disc in which the Lead-In of said at least one further session specifies that there are at least two tracks on the disc arranged in one or more further sessions departs from the standards. It has been found that the Microsoft operating systems specified are unable to reconcile the data on the disc when presented with this particular non-standard format whereby the operating systems are prevented from accessing the audio on the disc. This enables the provision of a multiple session optical disc which is copy protected.

In one embodiment of the present invention, the information in the Lead-In of the or each further session accurately identifies the configuration of the further session or sessions. The two or more tracks may be provided in one further session only. Alternatively, more than one further session may be provided across which the two or more tracks are distributed.

Where there is only one further session, it may include two or more data tracks. Alternatively, the one further session may include a first data track followed by a second audio track, and additional data and/or audio tracks may be provided.

Where the further session has more than one track, and the Lead-In accurately identifies the existence of those tracks, the Lead-In to the further session will identify part of the program area of the further session as an additional track such as an audio track or a second data track.

It will be appreciated that the present invention exploits a weakness in the specified operating systems which fail to reconcile the data on a disc with a non-standard format. Specifically, it is the provision of information in the Lead-In to a further session which identifies the existence of more than one track in a data session which causes the problems for the specified operating systems. In additional and/or alternative embodiments of the invention, information is provided in the Lead-In to a further session which erroneously identifies the existence of additional tracks in that session. In this case, the additional tracks are non-existent.

It has been explained that the provision of the non-standard format causes the specified operating systems to fail to access audio information on the disc. Specifically, the content of the Lead-In to said at least one further session acts to prevent drivers which are in one of the specified operating systems from accessing the audio data in a first, audio, session.

For example, the content of the Lead-In to said at least one further session acts to prevent drivers which are in a chain of drivers for an application player according to the Windows standard driver mode from accessing the audio data. The content of the Lead-In to said at least one further session, for example, is arranged to prevent a Windows system driver from accessing the audio data.

Additionally and/or alternatively, where the disc has a plurality of tracks in the further session, a method of an embodiment of the invention may further comprise showing in the Lead-In of said further session an order of the plurality of tracks which does not comply with the standards. The Lead-In may, or may not, show the order of the tracks in the further session accurately.

In an embodiment, there is a plurality of tracks in the further session and those tracks are provided in an order which does not comply with the standards. The Lead-In to the further session accurately represents the order of the tracks of the plurality.

Additional and/or alternatively, said further session has a first track and at least one additional track, and the method may further comprise providing that selected ones of the additional tracks are arranged to be non-compliant with the standards. For example, a single additional track provided may be made shorter than is required by the standards.

It will be appreciated that the length of the track is shown in the Lead-In to said further session.

### BRIEF DESCRIPTION OF THE DRAWINGS

Embodiments of the present invention will hereinafter be described, by way of example, with reference to the accompanying drawings, in which:

FIG. 1 shows schematically a compact disc showing the spiral data track,

FIG. 2 shows the structure of a frame of data encoded on a CD,

FIG. 3 illustrates the general data format of the Q-subchannel,

FIG. 4a shows the format of several modes of the data for the Q-subchannel,

FIG. 4b shows the format of the data for the Q-subchannel according to Mode 1,

FIG. 5 shows graphically both Atime and Ttime on a compact disc,

FIG. 6 shows the encoding of the TOC in the Lead-In area of the second session of a two session optical disc as illustrated in FIG. 7,

FIG. 7 shows schematically a two session copy protected optical disc of the invention illustrating the format of the information and control data,

FIG. 8 shows schematically the reading of an optical disc by a drive cooperating with a computer, and

FIG. 9 shows schematically the reading of a multiple session disc by a user application.

### DESCRIPTION OF PREFERRED EMBODIMENTS

All the features and advantages of the present invention will become apparent from the following detailed description of its preferred embodiments whose description should be taken in conjunction with the accompanying drawings.

A digital audio compact disc (CD-DA), which carries music and is to be played on an audio player such as a conventional CD disc player, is made and recorded to a standard format known as the Red Book standards. As well as defining physical properties of the disc, such as its dimensions, and its optical properties, such as the laser wavelength, the Red Book also defines the signal format and the data encoding to be used.

As is well known, the Red Book standards ensure that any CD-DA produced to those standards will play on any audio player produced to those standards.

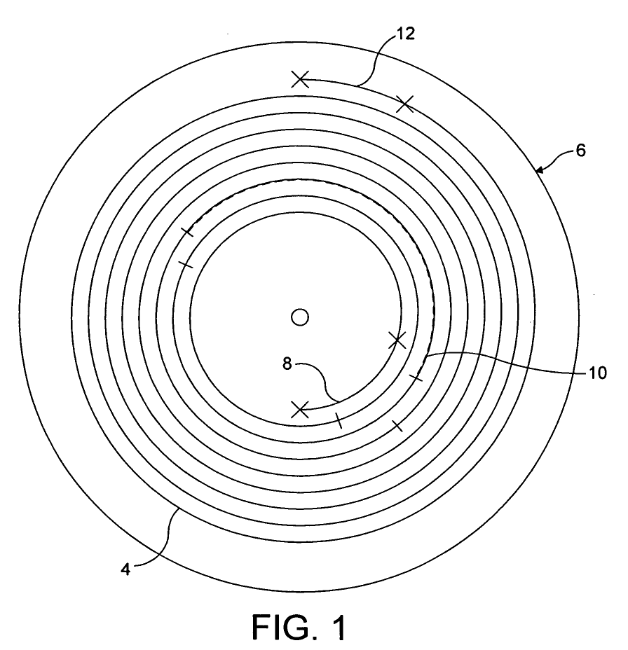

FIG. 1 shows schematically the spiral track 4 on a CD 6. This spiral track 4 on a CD-DA is divided into a Lead-In 8 at an inner area of the disc, a number of successive music or audio tracks as 10, and a Lead-Out 12 at an outer area of the disc. The Lead-In track 8 includes a Table of Contents (TOC) which identifies for the audio player the tracks to follow. The Lead-Out 12 gives notice that the track 4 is to end.

An audio player always accesses the Lead-In track 8 on start up. The music tracks may then be played consecutively as the read head follows the track 4 from Lead-In to Lead-Out. Alternatively, the player navigates the read head to the beginning of each audio track as required.

To the naked eye, a CD-ROM looks exactly the same as a CD-DA and has the same spiral track divided into sectors. However, data readers, such as CD-ROM drives, are much more sophisticated than compact disc players and are enabled to read data, and process information, from each sector of the compact disc according to the nature of that data or information. A data reader can navigate by reading information from each sector whereby the read head can be driven to access any appropriate part of the spiral track 4 as required.

To ensure that any data reader can read any CD-ROM, the compact discs and readers are also made to standards known, in this case, as the Yellow Book standards. These Yellow Book standards incorporate, and extend, the Red Book standards. Hence, a data reader, such as a CD-ROM drive, can be controlled to play a CD-DA.

As the data encoding on a CD-DA and on a CD-ROM is well known and in accordance with the appropriate standards, it will only be briefly described herein.

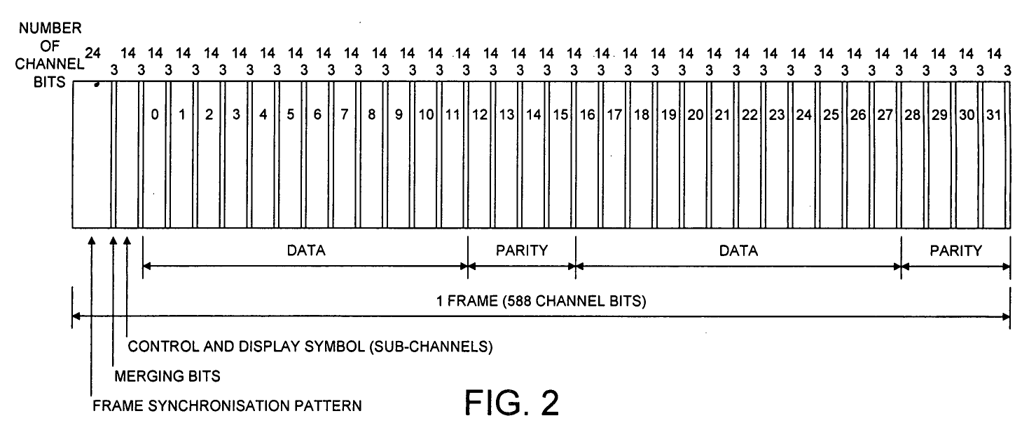

The data on a CD is encoded into frames by EFM (eight to fourteen modulation). FIG. 2 shows the format of a frame, and as is apparent therefrom, each frame has sync data, sub-code bits providing control and display symbols, data bits and parity bits. Each frame includes 24 bytes of data, which, for a CD-DA, is audio data.

There are 8 sub-code bits contained in every frame and designated as P, Q, R, S, T, U, V and W. Generally only the P and Q sub-code bits are used in the audio format. The standard requires that 98 of the frames of FIG. 2 are grouped into a sector, and the sub-code bits from the 98 frames are collected to form sub-code blocks. That is, each sub-code block is constructed a byte at a time from 98 successive frames. In this way, 8 different subchannels, P to W, are formed. These subchannels contain control data for the disc. The P-and Q-subchannels incorporate timing and navigation data for the tracks on the disc, and generally are the only subchannels utilised on an audio disc.

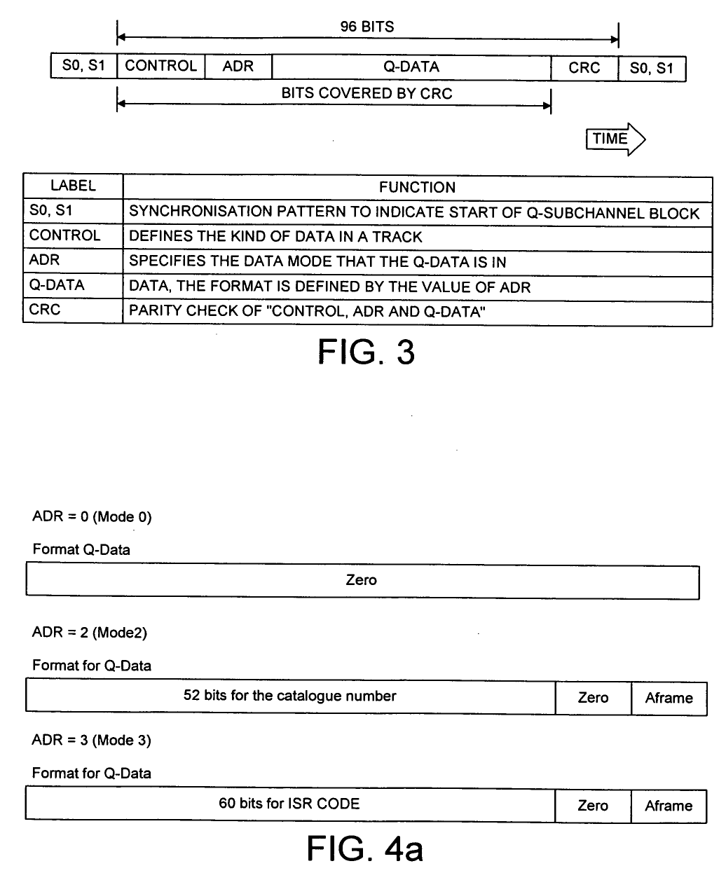

The data format for a Q-subchannel block assembled from 98 successive frames is indicated in FIG. 3. As is apparent, the start of the subchannel block is indicated by the appearance of sync patterns S0 and S1 as the first 2 symbols. The next data bits are control bits to define the contents of a track. Thus, the control bits might identify audio content or data content. There then follows address information, ADR, which specifies one of several modes for the Q-data bits. 72 bits of Q-data succeed the address information, and then there are 16 CRC, or check, bits which are used for error detection on the control, address and Q-data bits.

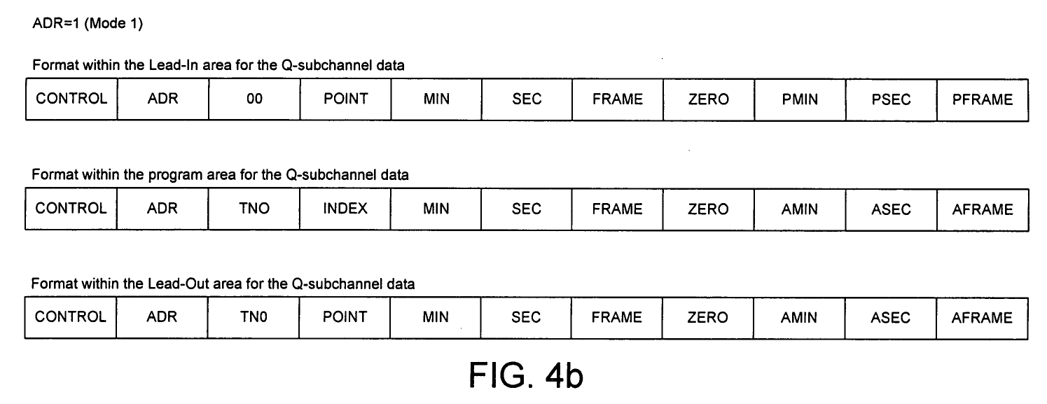

FIG. 4a illustrates the data content of a Q-subchannel block in each of three modes designated by the address information, ADR. In Mode 0, all of the Q-data has a value of zero. In Mode 2, the Q-data comprises a catalogue number for the disc, such as a bar code of the Universal Product Code. In addition, in Mode 2 the Aframe component of the time count from adjacent blocks is continued. Mode 3 is used to give ISR code for identifying each music track. In addition, and as is illustrated, in Mode 3 the absolute time count, Atime, is continued.

In Mode 1, as illustrated in FIG. 4b, the Q-data in each subchannel block contains program and time information for individual audio tracks and for the information area of the disc. As is illustrated, there is a different format for the Q-data for the Lead-In area to that within the program and Lead-Out areas. In the program and Lead-Out areas, the Q-data includes information about the absolute time, Atime, on the disc in minutes, seconds and frames, and Amin, Asec and Aframe are all components of Atime. In Mode 1, the running time of a track is in minutes, seconds and frames as indicated by Min, Sec, Frame.

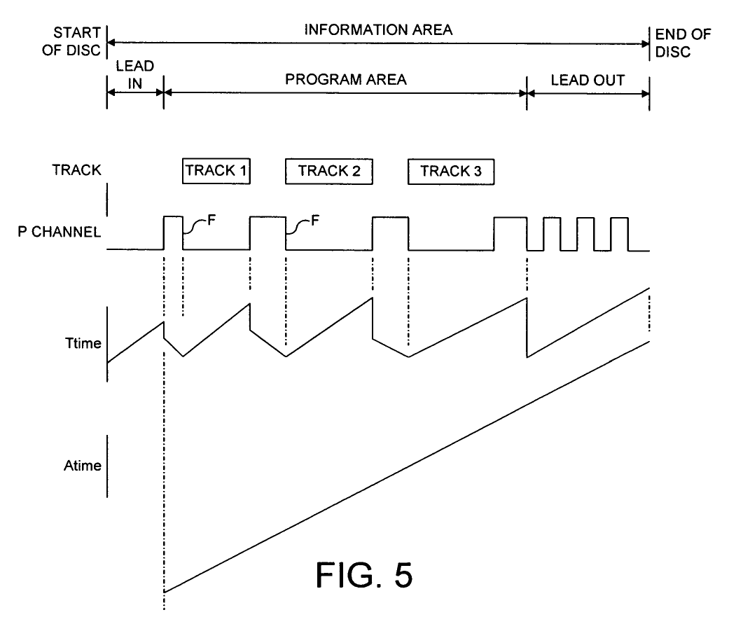

FIG. 5 shows graphically how Atime varies across a disc. Atime is the absolute time across the disc and starts at zero at the beginning of the program area. Thus, Atime increases monotonically across the disc. FIG. 5 also shows the running time within each track. This is noted as Ttime on FIG. 5 and starts at zero at the beginning of each track and increases along each individual track. As is also illustrated in FIG. 5, the P-subchannel includes flags F which each indicate the start of a respective track. The P-subchannel flags also designate the Lead-Out area.

The Mode 1 Q-data in the Lead-In area provides the Table of Contents (TOC). In the TOC items are repeated three times in successive Q-subchannel blocks and the complete TOC is continuously repeated during the Lead-In area. Within the Lead-In area for the Q-subchannel data the items Min, Sec, Frame identify the absolute or Atime. When POINT is any value between 01 and 99, Pmin, Psec and Pframe contain the start address of the track pointed to by POINT.

When POINT is set at $A0, Pmin contains the first track number in the program area whilst Psec specifies the session format. As set out below, the session can be an audio session or one of various types of data sessions.

When POINT is set to $A1, Pmin contains the track number of the last track in the program area, and when POINT is set to $A2, Pmin, Psec and Pframe give the start address of the Lead-Out area. As specified above, it is the control bits which identify the nature of the data within the program area. Generally when CONTROL is set to 0 it indicates an audio track.

The types of data carried on optical discs, and the data formats, have developed since the original CD-DAs were first commercially produced. For example, the information carried by optical discs may now comprise not only audio, numerical, or written data, but video, graphics, programs, computer and other data. Furthermore, optical discs may no longer include just a single information session as shown in FIG. 1 in which information extends between a Lead-In 8 and a Lead-Out 12.

Multiple session optical discs were developed, for example, to enable the recording of subsequent information onto recordable optical discs. However, pre-recorded multiple session discs are now available and encoding thereof is according to Orange Book standards. In addition, Sony and Philips have issued a standard to which audio multiple session discs have to comply to ensure compatibility with drives and operating systems. The information given above as to the encoding of the Q-subchannel data is in accordance with the Sony and Philips standard which is also known as the Blue Book standard.

In a general multiple session format, a plurality of separate sessions are arranged sequentially along the spiral track of the disc from the inner area thereof to the outer area thereof. Each session has a program area, between a respective Lead-In and a respective Lead-Out. Each session may be an audio session or a data session. Each session is provided with appropriate control data and this is generally the same and in the same format as if the session were the only session on the optical disc.

However, to ensure that a data reader is aware of the existence of all of the sessions on the disc, and to ensure that the data reader can navigate all of the sessions, control data from earlier sessions is repeated in subsequent sessions. Thus, the Lead-In to the last session of the disc, contains not only Lead-In control data specific to that session but also Lead-In control data from all of the preceding sessions. Similarly, the Lead-Out of each session may additionally include control data from the Lead-Outs of each preceding session, and the Lead-Out of the last session would then include not only control data specific to that last session but control data from the Lead-Outs of all of the preceding sessions. Alternatively, each Lead-Out may include control data identifying the existence of earlier sessions in addition to the control data specific to that session.

As we have seen above, there are standards as to the structure of the information recorded on optical discs. One such standard is the ISO 9660 standard which sets down the arrangement of information on an optical disc and requires the provision of standard indexes to describe the contents of a data session.

Briefly, the information in the data session or sessions is arranged in files. The interrelationship of each file with other files, and the location and attributes of the files are recorded in directories. These directories are arranged in a hierarchical relationship with a root directory and a plurality of other sub-directories. The files and directories together constitute a volume which additionally includes volume descriptors, directory descriptors and file descriptors. The descriptors contain descriptive information about the corresponding volume, directories and files and also contain information as to the structure of the volume. To enable all of the information in the volume to be accessed, each directory is identified in at least one other directory, and the root directory is identified either in a primary volume descriptor (PVD) or in a supplementary volume descriptor (SVD).

The ISO 9660 standard is well known and need not be further identified herein. Full details of the technically identical ECMA-119 are available at www.ecma.ch.

An audio disc according to the Blue Book standard has only two sessions, namely an audio session followed by a data session. According to the standard, all of the tracks in the program area of the audio session are audio tracks, whilst the following data session has just a single data track in its program area.

It has been proposed to copy protect the audio information on such an audio disc by introducing errors into the second session. Such errors are generally hidden from audio players, but can prevent disc readers from accessing the audio information.

However, the applicants have now determined that to prevent copying of audio discs it is not essential to introduce errors into the information and/or control data on the disc, at least where copying is to be undertaken using several common Windows operating systems. If, instead, the disc is arranged to breach the rules of, for example, the Blue Book standard it has been found that at least the Windows NT, Windows 2000 and Windows XP operating systems will fail to reconcile the data on the disc and will be prevented thereby from copying the audio information on the disc.

Thus, copy protection can be achieved by exploiting weaknesses in existing operating systems.

FIG. 7 shows one embodiment of a multiple session optical disc which provides copy protection for its audio information by having a format which does not comply with the Blue Book standard set out above. In the embodiment shown in FIG. 7, the optical disc has just two sessions, namely a first audio session 40 and a second data session 60. The data session 60 has the conventional structure of a Lead-In LI, a program area 32, and a Lead-Out LO. It also has a primary volume descriptor 50 containing control data identifying the files within the data session.

The audio session 40 has a program area 32 extending between the Lead-In LI and the Lead-Out LO. However, as this is an audio session, with the program area containing only audio data, there is no PVD in the program area 32 of the first session 40.

The data in the data session 60 can be made useful for a data player, for example, in that it may include the audio data of the audio session in files in a data session format. This will enable a digital player to access the audio on the disc from the second rather than from the first session.

As indicated above, the format of the disc is made non-standard to provide copy protection for the audio content on the disc when ripping software utilises the specified operating systems to try to access the audio data on the disc.

In the Blue Book standard the data session 60 has only a single data track. However, in the embodiment of the invention as shown in FIG. 7, for example, the data session 60 has a first data track 70 and a second track 80. This second track 80 may be a data track or an audio track. As shown in FIG. 7, there is also a pointer P in the Lead-In to the data session 60 which addresses the second track 80.

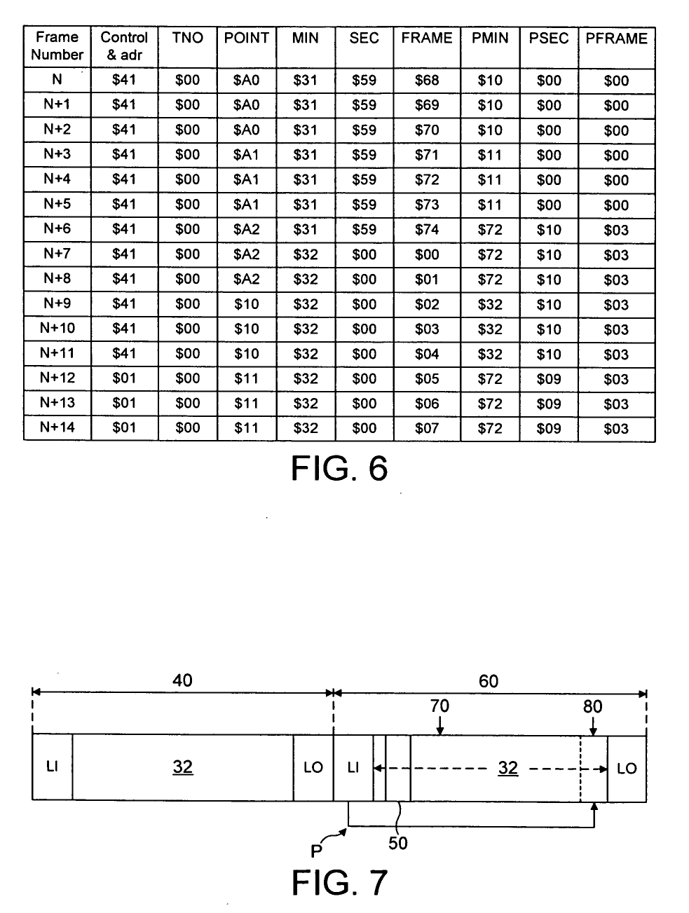

FIG. 6 shows part of the Lead-In for the second data session 60 where the second track 80 is an audio track. Thus, and as indicated in FIG. 6, the content at frames N+12, N+13 and N+14 of the TOC of the second session 60 is indicated as an audio track by the setting of CONTROL to 0. This control data provides the pointer P addressing the audio track 80.

The TOC also identifies that the second data session 60 includes two tracks 70 and 80. In this respect, and as can be seen at frames N and N+3 of FIG. 6 the POINT A1 has a higher associated value of Pmin than the POINT A0 indicating the existence of a second track.

t has been found that the provision of such a non-standard format prevents ripping software not only from accessing the audio track 80 but from also seeing the other audio tracks on the disc. In this way, the audio information on the disc is protected against the ripping software.

As described, the additional track in the second session is an audio track. However, if preferred, the additional track could be a second data track.

Additionally and/or alternatively, the second data session 60 may be provided with a first data track 70 and with more than one additional track, as 80, which may be data or audio tracks. The or each such additional track is addressed by the information in the Lead-In area L1 of the second session. For example, a pointer, as pointer P, may address each such additional track.

The additional track or tracks in the second session may be in accordance with the Yellow and Orange Book standards, for example, or selected ones of, or all of, the additional tracks may be non-compliant with the standards.

The nature of the non-compliance of the additional track or tracks may be chosen as required. For example, the length of any additional track, that is the time thereof, may be outside the time requirements in the standards. In an embodiment, the or each additional track may be shorter than the standards require.

It has been determined that the provision of a non-compliant additional track or tracks in the second session can prevent some applications from accessing the first, audio session.

As will be explained further below, it is not generally the provision of more than one track in a data session, for example, which causes ripping software to fail. Rather, ripping software, particularly when utilising the specified operating systems, fails to reconcile the data on the disc, and to access the audio on the disc, when the Lead-In to the second data session reveals the existence of a non-standard format, and specifically the existence of more than one track in the second session.

In the embodiment illustrated in FIG. 7, the second data session 60 is provided with two tracks 70 and 80 and the pointer P identifies the existence of the second track 80. However, it would alternatively be possible to have only a single data track, as 70, in the second session but to keep the pointer P. The pointer P would then address an area of the program area at which there is no additional track.

Similarly, the Blue Book standard requires the provision of two sessions only, namely an audio session followed by a data session. It is additionally possible to provide for copy protection of the disc by providing two or more data sessions following the audio session, rather that the single data session 60 as illustrated in FIG. 7. Each such data session may have a single track, or one or more tracks. The tracks in each data session may be data tracks or data and audio tracks. The Lead-In to the last data session, for example, will reveal the presence of more than one data session and this information will cause ripping software utilising the specified operating systems to fail.

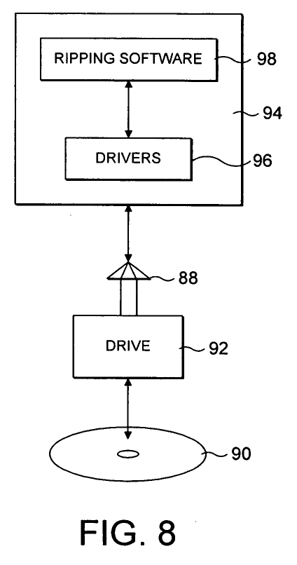

FIG. 8 shows schematically the reading of data from an optical disc 90 by a drive 92 and also shows how ripping software 98 loaded on a computer accesses the optical disc. Thus, the disc 90 is read by a drive, indicated at 92 which outputs the information at a port 88. If the audio on the disc 90 is to be played, the output information at port 88 is passed to the driver of a loudspeaker (not shown). It is the drive 92 which decodes and interprets the information carried on the disc 90. In this respect, with a disc of a non-standard format as provided by the invention, the drive 92 has no difficulty in accessing and using all of the information on the disc.

FIG. 8 also shows schematically the use of ripping software 98 loaded onto a computer to copy the information on the disc. The computer will incorporate an operating system 94. In this respect, the invention exploits weaknesses in Microsoft's Windows operating systems such as Windows NT version 4 and higher, Windows 2000, and Windows XP. Such operating systems 94 incorporate drivers 96 which receive the information output to port 88 of the reading device 92. The ripping software 98 accesses the information from the disc 90 by way of these drivers 96.

For data sessions, the control information read from the disc by the drive 92 is passed to the operating system 94 separately from the data in the files of the data session. It has been found that when the specific operating systems identified find from the control information read from the disc that there are at least two tracks arranged over one or more data sessions, the operating system is unable to reconcile the data on the disc. Furthermore, the operating system is prevented from seeing and hence copying the audio tracks on the disc.

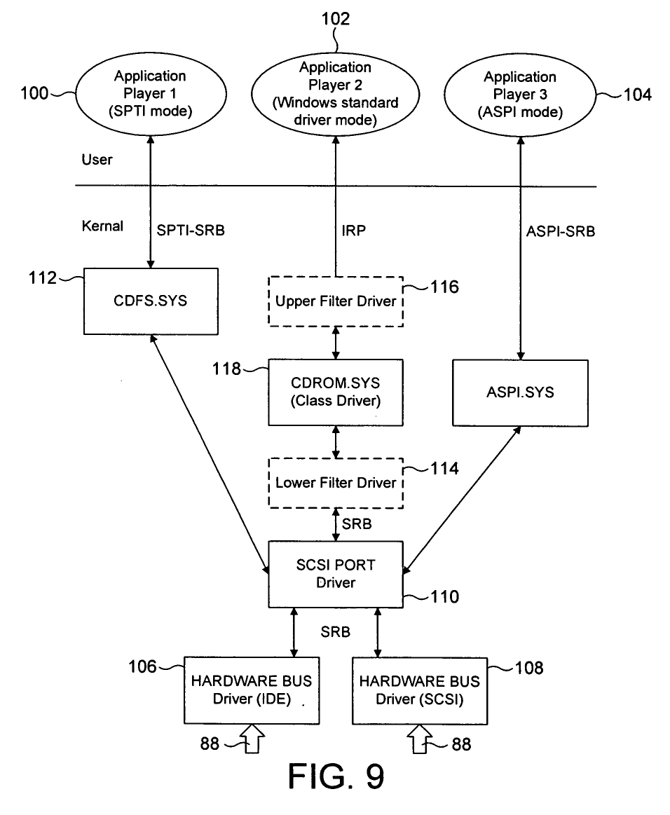

FIG. 9 shows schematically the reading of the data from an optical disc, as indicated in FIG. 8, in more detail. In this respect, the information retrieved from the disc 90 by way of the drive 92 is applied to the port 88. A user will use an application such as one of three application players 100, 102, 104 to access the information at port 88 by way of an appropriate one of two drivers 106, 108. In this respect, in the arrangement shown in FIG. 9, the driver 106 utilises an IDE interface to access the information from the disc whereas the driver 108 utilises a SCSI interface. The information retrieved by either driver 106, 108 from the disc is interpreted by elements of the computer's operating system using the programs generally shown in FIG. 9. As indicated previously, the programs illustrated in FIG. 9 are conventionally provided in Microsoft operating systems such as Windows NT version 4 and higher, Windows 2000, and Windows XP.

It will be seen from FIG. 9 that the information from port 88 is retrieved by way of the driver 106 or 108 and is then is passed by way of a port driver 110 along one of three possible paths dependent upon the application player to be utilised. Thus, where the application player 100 is used to access the disc, the information is interpreted by a CD file system program CDFS.SYS 112 which can access the files in the data session 60. Where those files contain the audio from the disc, the player 100 is enabled to play the audio on the disc. However, such a player cannot access the audio session 40.

The application player 102 utilises, as shown, Windows standard driver mode and ripping software for use in conjunction with such players is readily available. However, it has been found that the reference to plural tracks in the Lead-In to the second session, and/or the presence of non-compliant tracks in the second session, prevent drivers provided between the port driver 110 and the player 102 from passing the audio tracks to the player 102. In this respect, it will be appreciated that if the player 102 cannot access the audio tracks, it cannot copy them.

It will be seen in FIG. 9 that there are optional filter drivers 114 and 116 in the path from the port driver 110 to the player 102. In addition, there is a generic driver 118 which runs CDROM.SYS.

The driver 118 interprets the data on the disc received from drivers as 110 and 114 and, according to convention, it will read the TOC of the second session first. It has been found that the provision of pointers, as P, to additional tracks and/or the provision of non-complaint tracks causes CDROM.SYS to ignore all of the audio tracks on the disc.

It will be appreciated that format changes other than those described above may additionally or alternatively be incorporated a disc, and recorded in the TOC of the second session, in order to prevent access by a player such as 102 to the audio data on the disc.

The Sony and Philips standard requires, for example, that the first track in a data session be a data track and that, within a data session an audio track cannot be followed by a data track. If the second session, and/or the TOC of the second session is altered such that these rules are breached, CDROM.SYS will be unable to reconcile the data on the disc and again will be prevented from having access to the audio on the disc.

The present invention has been described above by reference to the provision of information and control data on a disc in a non-standard format. This, as described, prevents copying of a disc by the use of certain specified operating systems. If required, the optical disc may also be provided with errors in its second session to provide enhanced copy protection.

It will be appreciated that modifications to and amendments of the embodiments as described and claimed may be made within the scope of this application.

1. A method of preventing copying of an optical disc, where the optical disc carries information and control data for enabling access to the information, the method comprising providing an optical disc having the information thereon arranged in a first session and in at least one consecutively arranged further session, each of said first and further sessions having a Lead-In, a program area, and a Lead-Out, and the first session being an audio session having audio data in its program area, wherein to prevent copying of the information on the optical disc when utilising a Microsoft operating system in the group: Windows NT, Windows 2000 and Windows XP, the Lead-In of said at least one further session specifies that there are at least two tracks on the optical disc arranged in one or more further sessions.

2. A method of preventing copying of an optical disc according to claim 1, further comprising providing an optical disc having one said further session, said further session being a data session and including said at least two tracks in its program area.

3. A method of preventing copying of an optical disc according to claim 2, wherein the two or more tracks in the program area of said further session are data tracks.

4. A method of preventing copying of an optical disc according to claim 3, further comprising providing in the Lead-In to said further session control data which identifies part of the program area of the further session as a second data track.

5. A method of preventing copying of an optical disc according to claim 2, wherein the two or more tracks in the program area of said further session include a first, data track, and a second, data audio track.

6. A method of preventing copying of an optical disc according to claim 5, further comprising providing in the Lead-In to said further session control data which identifies part of the program area of the further session as an audio track.

7. A method of preventing copying of an optical disc according to claim 2, wherein the information in the Lead-In of said further session accurately identifies the configuration of said further session.

8. A method of preventing copying of an optical disc according to claim 1, further comprising providing an optical disc having one said further session, said further session being a data session and including a single data track in its program area, and wherein the Lead-In of said further session erroneously indicates that there are two or more tracks in said program area.

9. A method of preventing copying of an optical disc according to claim 1, further comprising providing an optical disc having more than one further session, each of said further sessions being a data session and including at least one track in its program area such that there are two or more tracks arranged in the two or more further sessions.

10. A method of preventing copying of an optical disc according to claim 1, wherein the content of the Lead-In to said at least one further session acts to prevent drivers which are in one of the specified Microsoft Windows operating systems from accessing the audio data in the first, audio session.

11. A method of preventing copying of an optical disc according to claim 10, wherein the content of the Lead-in to said at least one further session acts to prevent drivers which are in a chain of drivers for an application player according to the Windows standard driver mode from accessing the audio data.

12. A method of preventing copying of an optical disc according to claim 11, wherein the content of the Lead-In to said at least one further session is arranged to prevent a Windows system driver from accessing the audio data.

13. A method of preventing copying of an optical disc according to claim 2, wherein there is a plurality of tracks in the further session and further comprising showing in the Lead-In of said further session an order of the plurality of tracks which does not comply with the standards.

14. A method of preventing copying of an optical disc according to claim 2, wherein there is a plurality of tracks in said further session, and further comprising providing the tracks of the plurality in an order which does not comply with the standards.

15. A method of preventing copying of an optical disc according to claim 2, wherein said further session has a first track and at least one additional track, and further comprising providing that selected ones of the additional tracks are arranged to be non-compliant with the standards.

16. A method of preventing copying of an optical disc according to claim 15, further comprising providing a single additional track and making the additional track shorter than is required by the standards.
